(19) United States
(12) Patent Application Publication
(10) Pub. No.: US 2020/0090117 A1
(43) Pub. Date: Mar. 19, 2020

(54) DELIVERY SYSTEMS AND METHODS

(71) Applicant: Ford Global Technologies, LLC, Dearborn, MI (US)

(72) Inventors: John Weizhong LUO, Dearborn, MI (US); Sudipto AICH, Dearborn, MI (US); Simon Murtha SMITH, Dearborn, MI (US); Alexander Silvio MULLER, Dearborn, MI (US); Jennifer L. BRACE, Dearborn, MI (US); Hyung Min BAEK, Dearborn, MI (US); Lynn Valerie KEISER, Dearborn, MI (US); Aysha HABBABA, Dearborn, MI (US)

(21) Appl. No.: 16/471,372

(22) PCT Filed: Dec. 19, 2016
(86) PCT No.: PCT/US2016/067549

§ 371 Date: Jun. 19, 2019

(51) Int. Cl. G06Q 10/08

(52) U.S. Cl. CPC G06Q 10/0832

(57) ABSTRACT

Example delivery systems and methods are described. In one implementation, a method identifies multiple items for delivery to a vehicle and determines whether any of the items are temperature-sensitive. If any of the items are temperature-sensitive, the method determines whether the vehicle has a variable-temperature compartment to receive the temperature-sensitive items. If the vehicle has a variable-temperature compartment, the vehicle is notified of an estimated delivery time for the temperature-sensitive items.

### TECHNICAL FIELD

The present disclosure relates to delivery systems and, more particularly, to delivering items to an unattended vehicle.

### BACKGROUND

Delivering an item, such as a package, to a vehicle typically requires a person (e.g., a vehicle owner) to be present at the vehicle to receive the package. For example, the person may physically meet a representative of a package delivery service at the vehicle to receive the package and/or unlock the vehicle to allow the representative to place the package in the vehicle. If the vehicle owner is not present when the delivery service representative arrives at the vehicle, the representative cannot access the vehicle. Attempting to schedule a specific time for delivering a package to a vehicle can be frustrating because the delivery service representative does not know an exact time they will arrive at the vehicle due to unknown variables such as traffic delays and the like. A delivery system that allows secure delivery of packages to unattended vehicles is beneficial to both the vehicle owner and the delivery service representative.

### BRIEF DESCRIPTION OF THE DRAWINGS

Non-limiting and non-exhaustive embodiments of the present disclosure are described with reference to the following figures, wherein like reference numerals refer to like parts throughout the various figures unless otherwise specified.

FIG. 1 is a block diagram illustrating an embodiment of a system for delivering an item to an unattended vehicle.

FIG. 2 is a block diagram illustrating an embodiment of a portion of a vehicle that includes multiple compartments for receiving items.

FIG. 3 illustrates an embodiment of a method for scheduling delivery of an item to an unattended vehicle.

FIG. 4 illustrates an embodiment of a method for receiving items delivered to an unattended vehicle.

FIG. 5 illustrates an embodiment of a method for managing power supplied to a variable-temperature compartment.

FIG. 6 illustrates an example block diagram of a computing device.

### DETAILED DESCRIPTION

In the following disclosure, reference is made to the accompanying drawings, which form a part hereof, and in which is shown by way of illustration specific implementations in which the disclosure may be practiced. It is understood that other implementations may be utilized and structural changes may be made without departing from the scope of the present disclosure. References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

Implementations of the systems, devices, and methods disclosed herein may comprise or utilize a special purpose or general-purpose computer including computer hardware, such as, for example, one or more processors and system memory, as discussed herein. Implementations within the scope of the present disclosure may also include physical and other computer-readable media for carrying or storing computer-executable instructions and/or data structures. Such computer-readable media can be any available media that can be accessed by a general purpose or special purpose computer system. Computer-readable media that store computer-executable instructions are computer storage media (devices). Computer-readable media that carry computer-executable instructions are transmission media. Thus, by way of example, and not limitation, implementations of the disclosure can comprise at least two distinctly different kinds of computer-readable media: computer storage media (devices) and transmission media.

Computer storage media (devices) includes RAM, ROM, EEPROM, CD-ROM, solid state drives (“SSDs”) (e.g., based on RAM), Flash memory, phase-change memory (“PCM”), other types of memory, other optical disk storage, magnetic disk storage or other magnetic storage devices, or any other medium which can be used to store desired program code means in the form of computer-executable instructions or data structures and which can be accessed by a general purpose or special purpose computer.

An implementation of the devices, systems, and methods disclosed herein may communicate over a computer network. A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmissions media can include a network and/or data links, which can be used to carry desired program code means in the form of computer-executable instructions or data structures and which can be accessed by a general purpose or special purpose computer. Combinations of the above should also be included within the scope of computer-readable media.

Computer-executable instructions comprise, for example, instructions and data which, when executed at a processor, cause a general purpose computer, special purpose computer, or special purpose processing device to perform a certain function or group of functions. The computer executable instructions may be, for example, binaries, intermediate format instructions such as assembly language, or even source code. Although the subject matter is described in language specific to structural features and/or methodological acts, it is to be understood that the subject matter defined in the appended claims is not necessarily limited to the described features or acts described herein. Rather, the described features and acts are disclosed as example forms of implementing the claims.

Those skilled in the art will appreciate that the disclosure may be practiced in network computing environments with many types of computer system configurations, including, an in-dash vehicle computer, personal computers, desktop computers, laptop computers, message processors, hand-held devices, multi-processor systems, microprocessor-based or programmable consumer electronics, network PCs, minicomputers, mainframe computers, mobile telephones, PDAs, tablets, pagers, routers, switches, various storage devices, and the like. The disclosure may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

Further, where appropriate, functions described herein can be performed in one or more of: hardware, software, firmware, digital components, or analog components. For example, one or more application specific integrated circuits (ASICs) can be programmed to carry out one or more of the systems and procedures described herein. Certain terms are used throughout the description and claims to refer to particular system components. As one skilled in the art will appreciate, components may be referred to by different names. This document does not intend to distinguish between components that differ in name, but not function.

It should be noted that the sensor embodiments discussed herein may comprise computer hardware, software, firmware, or any combination thereof to perform at least a portion of their functions. For example, a sensor may include computer code configured to be executed in one or more processors, and may include hardware logic/electrical circuitry controlled by the computer code. These example devices are provided herein purposes of illustration, and are not intended to be limiting. Embodiments of the present disclosure may be implemented in further types of devices, as would be known to persons skilled in the relevant art(s).

At least some embodiments of the disclosure are directed to computer program products comprising such logic (e.g., in the form of software) stored on any computer useable medium. Such software, when executed in one or more data processing devices, causes a device to operate as described herein.

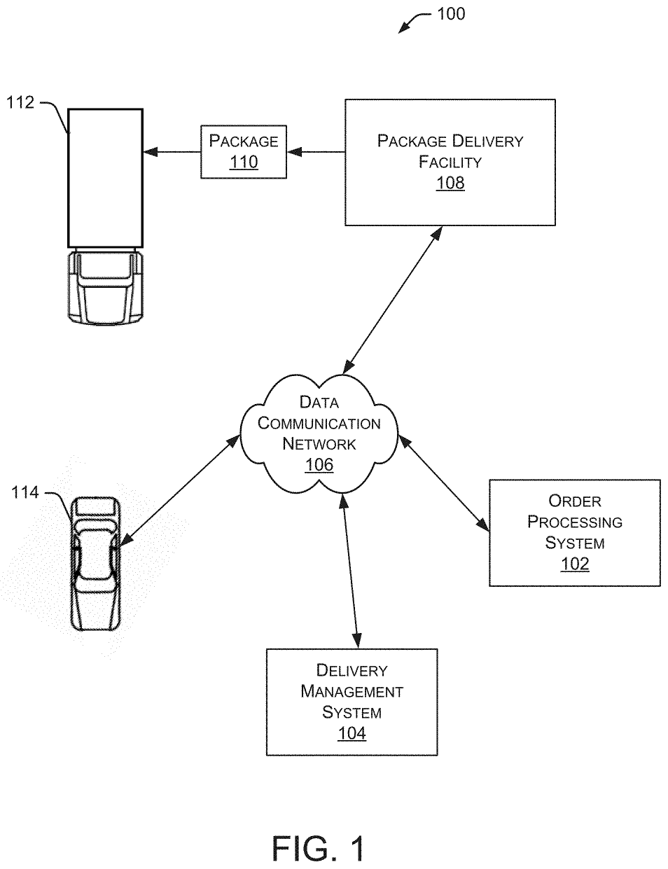

FIG. 1 is a block diagram illustrating an embodiment of a system 100 for delivering an item to an unattended vehicle. An order processing system 102 receives or identifies orders to be delivered to one or more customers. A particular order may include any number of items. Some items in an order may be temperature-sensitive and require an environment within a particular temperature range to keep the item, for example, from spoiling. Example temperature-sensitive items include frozen items, refrigerated items, and hot (i.e., heated) items. In some embodiments, the temperature-sensitive items are food items that must be maintained within particular temperature ranges to keep the food item from thawing, cooling, or spoiling. In other embodiments, the temperature-sensitive items are non-food items, such as medicine, flammable compounds, and the like.

A delivery management system 104 coordinates the delivery of items contained in an order to a customer. In some embodiments, delivery management system 104 manages the delivery of multiple items to the customer's unattended vehicle 114. Unattended vehicle 114 may be any type of vehicle, such as a car, truck, van, bus, and the like. Various delivery systems or delivery services may be used to deliver the items to unattended vehicle 114. For example, a third party package delivery service may deliver packages 110 from a package delivery facility 108 using one or more delivery vehicles 112. Package delivery facility 108 may include a warehouse or other structure capable of receiving and distributing multiple items. The items for a particular order may be grouped together as a single package 110 for delivery to unattended vehicle 114. A package 110 may include any type of container or carrier to carry the items in an order, such as a box, bag, carton, shipping tub, shipping bin, and the like. Delivery vehicle 112 may be driven by a representative of a package delivery service. In some embodiments, delivery vehicle 112 is an autonomous vehicle.

As shown in FIG. 1, a data communication network 106 supports the communication of data between multiple systems or devices, such as order processing system 102, delivery management system 104, package delivery facility 108 and unattended vehicle 114. Data communication network 106 represents any type of network, such as the Internet, and may utilize any communication protocol and any type of communication medium. In some embodiments, data communication network 106 is a combination of two or more networks coupled to one another.

Delivery management system 104 coordinates the delivery of items in an order to a customer. In some embodiments, the customer may desire delivery of the items to the customer's unattended vehicle 114. In this situation, delivery management system 104 determines whether any of the items are temperature-sensitive. If the order includes temperature-sensitive items, delivery management system 104 further determines whether unattended vehicle 114 has variable-temperature compartments capable of maintaining the appropriate environment (or environments) for the temperature-sensitive items. Additional details regarding the delivery of temperature-sensitive items to unattended vehicle 114 are discussed herein.

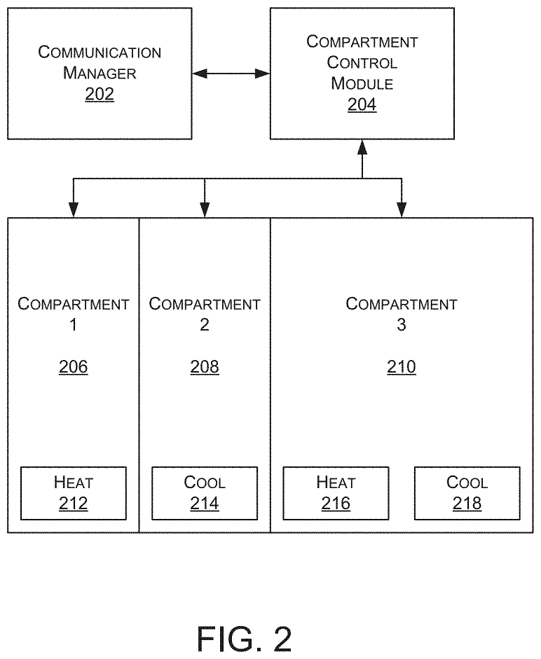

FIG. 2 is a block diagram illustrating an embodiment of a portion of a vehicle that includes multiple compartments for receiving items. In some embodiments, the components shown in FIG. 2 are contained within unattended vehicle 114. A communication manager 202 receives information from, for example, order processing system 102 and delivery management system 104. In some embodiments, communication manager 202 receives information related to an upcoming delivery to the vehicle. This delivery information may include the number of items, types of items (e.g., temperature-sensitive items), estimated delivery time, and the like.

Communication manager 202 provides the received delivery information to a compartment control module 204, which controls access to the vehicle (e.g., vehicle doors and trunk) as well as access to multiple compartments 206, 208, and 210 within the vehicle. Compartments 206-210 can be located anywhere within the vehicle, such as in a vehicle trunk, back seat, passenger area, and the like. Compartments 206-210 may have different sizes. In the example of FIG. 2, compartments 206 and 208 have a size that is smaller than compartment 210. Compartments 206-210 can store items delivered to the vehicle, as discussed herein. Although three compartments 206-210 are shown in FIG. 2, particular embodiments may include any number of compartments arranged in any configuration. FIG. 2 shows compartments 206-210 located next to one another. In alternate embodiments, compartments 206-210 can be located in different portions of the vehicle. For example, compartment 210 may be located in a vehicle trunk while compartments 206 and 208 may be located in the vehicle's passenger compartment.

In some embodiments, each compartment 206-210 can be locked and unlocked independently of the other compartments. In these embodiments, control module 204 controls the locking and unlocking of compartments 206-210.

In the embodiment of FIG. 2, compartment 206 has a heating module 212 that can control the temperature of compartment 206 within a particular range. If heating module 212 is not activated, compartment 206 will have a temperature similar to the ambient temperature surrounding compartment 206. Heating module 212 can use any type of heat source or heating element to heat compartment 206. In some embodiments, the existing HVAC (Heating, Ventilating, and Air Conditioning) system is used to heat or cool one or more compartments in the vehicle. In other implementations, a separate belt-driven system is powered by the vehicle engine. This belt-driven system may provide heating and/or cooling to one or more compartments in the vehicle. In some embodiments, a cooled compartment has temperatures comparable to a refrigerator or a freezer, and a heated compartment has a temperature comparable to a warming oven or other mechanism that maintains items at a temperature above a typical room temperature.

Compartment 208 has a cooling module 214 that can control the temperature of compartment 208 within a particular range. If cooling module 214 is not activated, compartment 208 will have a temperature similar to the ambient temperature surrounding compartment 208. Cooling module 212 can use any type of cooling source or cooling technique to cool compartment 208.

Compartment 210 includes a heating module 216 and a cooling module 218. These modules work in a manner similar to heating module 212 and cooling module 214 discussed above. By providing both heating module 216 and a cooling module 218 in compartment 210, the compartment is able to accommodate items that need a hot environment or items that need a cold environment. In some embodiments, heating module 216 and cooling module 218 are activated independently of one another depending on whether hot or cold environment is desired. If both heating module 216 and a cooling module 218 are deactivated, compartment 210 will have a temperature similar to the ambient temperature surrounding compartment 210.

Although each compartment 206-210 is shown to have at least one heating module or one cooling module, alternate embodiments may include one or more compartments that do not have a heating module or a cooling module. These compartments will have a temperature similar to the ambient temperature surrounding the compartment and can be used for items that are not temperature-sensitive. In some implementations, compartments 206-210 are insulated to assist in maintaining the desired temperature within the compartment. Compartments 206-210 have a lid, door, or other access mechanism that allows the compartment to be opened to insert or remove items. The lid, door, or other access mechanism is then closed to maintain the temperature within the compartment.

In some embodiments, one or more temperature indicators are attached to or located near compartments 206-210. For example, indicator lights may indicate whether a particular compartment is hot, cold, or at the ambient temperature. Additionally, the indicator lights may indicate that a particular compartment is being heated or cooled, but has not yet reached the desired temperature.

In particular implementations, heating and cooling modules 212-218 are powered by the vehicle's battery. In alternate implementations, heating and cooling modules 212-218 are powered by another power source associated with the vehicle or external to the vehicle.

In some embodiments, one or more compartments 206-210 may also include a humidity control module that can increase or decrease the humidity of the compartment. The humidity control module is particularly useful for items that require a specific humidity level, such as a dry environment or a humid environment.

In particular implementations, some items require safe storage temperature ranges. For example, some electronic equipment has a wide range of safe storage temperatures, but should not be exposed to extreme heat or extreme cold. For these items, the systems and methods described herein may instruct a delivery service to deliver the items into a compartment that can heat and/or cool the environment. The systems and methods can then activate the heating or cooling modules, as appropriate, to keep the item within the range of safe storage temperatures. Thus, although these types of items are not traditional temperature-controlled or temperature-sensitive items, they still have a safe range of temperatures when being stored.

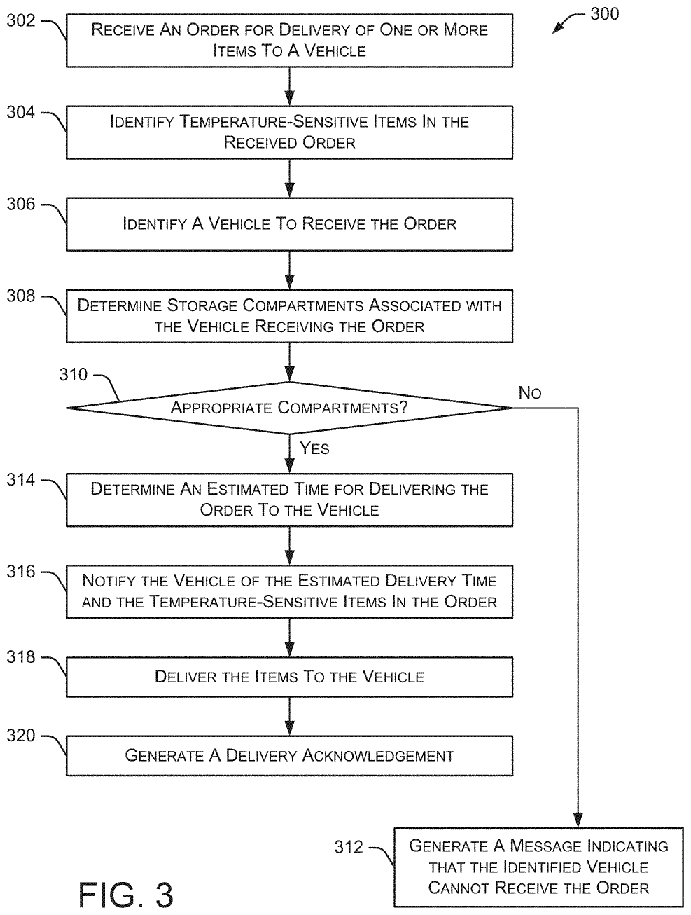

FIG. 3 illustrates an embodiment of a method 300 for scheduling delivery of an item to an unattended vehicle. Initially, method 300 receives 302 an order for delivery of one or more items to a vehicle, such as an unattended vehicle. The method identifies 304 any temperature-sensitive items in the received order, including identifying whether the items require a heated environment or a cooled environment. Method 300 also identifies 306 a vehicle to receive the order and determines 308 what kind of storage compartments are available in the vehicle that will be receiving the order. For example, the method may determine the number of compartments, the size of the compartments, and the types of compartments (e.g., heated, cooled, or ambient temperature). Based on the identified temperature-sensitive items and the vehicle's available compartments, method 300 determines 310 whether the vehicle has appropriate compartments to receive the order. For example, the method may determine if the heated compartment is large enough to accommodate temperature-sensitive items that need heat and if the cooled compartment is large enough to accommodate temperature-sensitive items that need cooling. If the vehicle's compartments are not appropriate for the items in the order, a message is generated 312 indicating that the identified vehicle cannot receive the order.

If the vehicle's compartments are appropriate at 310 for the items in the order, method 300 determines 314 an estimated time for delivering the order to the vehicle. The estimated delivery time is determined using any existing systems and algorithms that determine, for example, delivery schedules, delivery routes, and the like. The vehicle is notified 316 of the estimated delivery time and the temperature-sensitive items in the order (including whether the temperature-sensitive items require a heated environment or a cooled environment). In some embodiments, the vehicle is notified of a specific temperature range (e.g., 40-45 degrees Fahrenheit) or a specific temperature (e.g., 42 degrees Fahrenheit) that is required for one or more of the temperature-sensitive items. The items in the order are delivered 318 to the vehicle at the appropriate time. After the items are delivered to the vehicle, a delivery acknowledgement message is generated 320 and communicated, for example, to a vehicle owner, a delivery management system, an order processing system, and the like.

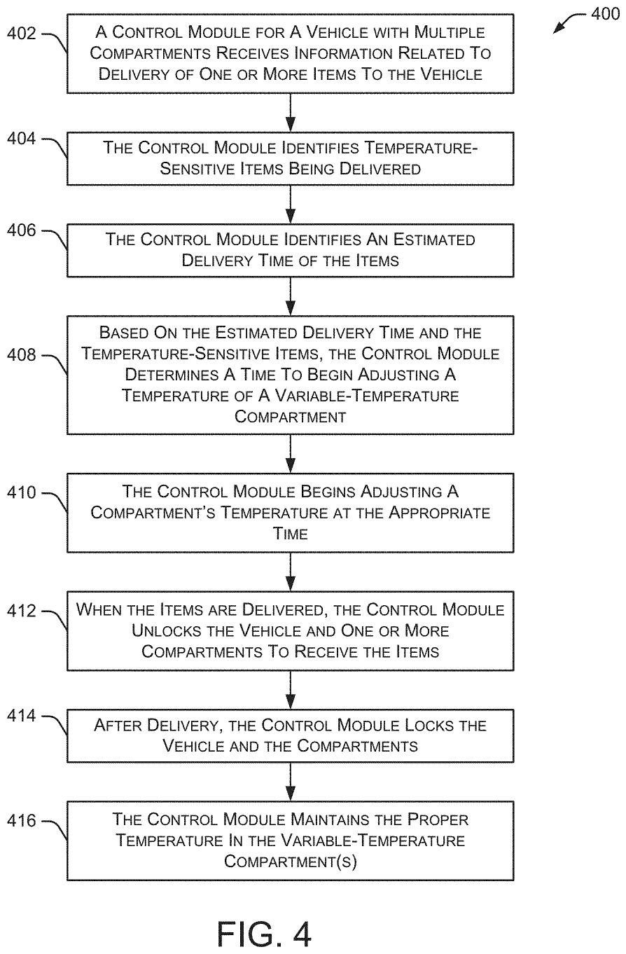

FIG. 4 illustrates an embodiment of a method 400 for receiving items delivered to an unattended vehicle. Initially, a control module for a vehicle with multiple compartments receives 402 information related to delivery of one or more items to the vehicle. The control module identifies 404 temperature-sensitive items being delivered, including whether the items require a heated environment or a cooled environment. In some embodiments, the delivery information received at 402 includes specific temperature ranges (or specific temperatures) necessary for certain temperature-sensitive items being delivered. Next, the control module identifies 406 an estimated delivery time of the items. The estimated delivery time may be included in the delivery information received at 402. Based on the estimated delivery time and the temperature-sensitive items, the control module determines 408 a time to begin adjusting a temperature of a variable-temperature compartment. The time to begin adjusting the temperature of the variable-temperature compartment may vary depending on the ambient temperature surrounding the compartment and the speed at which a heating module or cooling module in the compartment can change the internal temperature of the compartment. For example, on a hot day, it may take longer to cool a variable-temperature compartment. Similarly, on a cool day, it may take longer to heat a variable-temperature compartment. Additionally, a variable-temperature compartment with a powerful heating module may heat the compartment faster than a compartment with a less powerful heating module. Similarly, a variable-temperature compartment with a powerful cooling module may cool the compartment faster than a compartment with a less powerful cooling module. All of these factors are considered when determining 408 when to begin adjusting a temperature of a variable-temperature compartment.

The control module begins adjusting 410 a compartment's temperature at the appropriate time. When the items are delivered, the control module performs an authentication process to authenticate the delivery person (e.g., a representative of a delivery service) prior to providing access to the unattended vehicle. The authentication process can use any system, algorithm, or technique known to those of ordinary skill in the art. After the delivery person is authenticated, the control module unlocks 412 the vehicle and unlocks one or more compartments in the vehicle to receive the items being delivered. In some embodiments, only a portion of the items being delivered are placed into a compartment. Other items can be placed next to the compartments or elsewhere in the vehicle. For example, heated items may be placed in a heated compartment, cooled items may be placed in a cooled compartment, and the remaining items (which do not have heating or cooling requirements) are placed in the vehicle's trunk or passenger compartment.

After delivery of the items, the control module locks 414 the vehicle and the compartments. In some embodiments, the compartments do not have separate locks. In these embodiments, the compartments are secure within the vehicle when the vehicle's doors and other access points are locked. The control module then maintains 416 the proper temperature in the one or more variable-temperature compartments until the items are retrieved by a vehicle owner or other individual. After the items are retrieved from the variable-temperature compartments, the control module may deactivate the heating and/or cooling modules in the compartments.

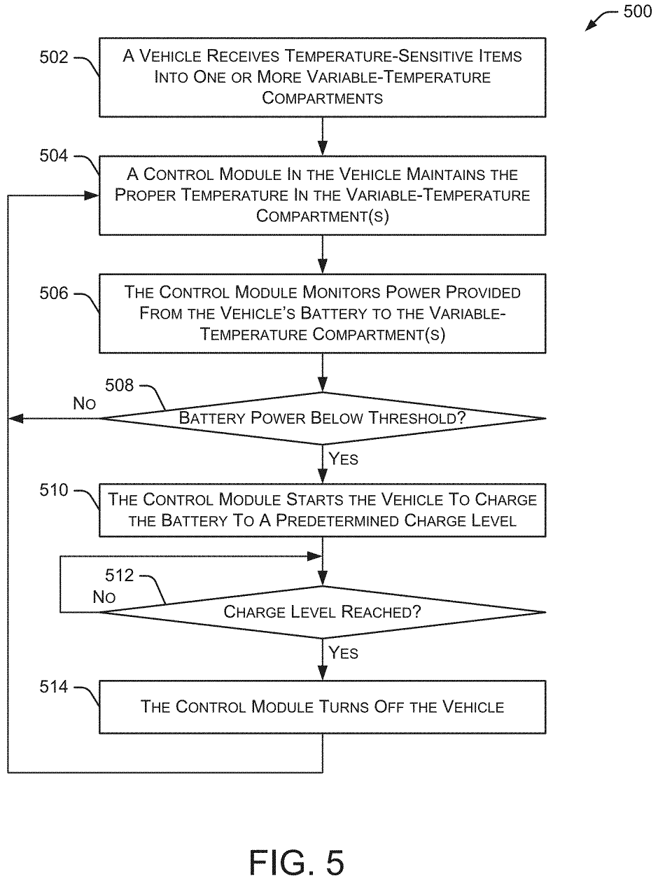

FIG. 5 illustrates an embodiment of a method 500 for managing power supplied to a variable-temperature compartment. Initially, a vehicle receives 502 temperature-sensitive items into one or more variable-temperature compartments. A control module in the vehicle maintains 504 the temperature in the variable-temperature compartments. The control module also monitors 506 the power provided from the vehicle's battery to the variable-temperature compartments. If the control module determines 508 that the battery power falls below a threshold value, the control module starts 510 the vehicle's engine to charge the battery to a predetermined charge level. In some embodiments, the predetermined charge level is no less than the level that provides sufficient power, as determined by the vehicle's Battery Monitoring System, required to start the vehicle's engine at a later time. The Battery Monitoring System is responsible for monitoring and maintaining the health of the vehicle's battery.

When the predetermined charge level is reached at 512, the control module turns off 514 the vehicle's engine and continues maintaining 504 the proper temperature in the variable-temperature compartments. In some embodiments, the control module determines whether the vehicle is in an enclosed area (such as a closed garage) before starting the vehicle engine. If the vehicle is not in an well-ventilated area, the control module will not start the vehicle engine. In particular embodiments, the control module will generate a message that is communicated, for example, to a vehicle owner indicating that the battery power is below the threshold value. This message gives the vehicle owner (or other individual) an opportunity to retrieve the items or take other action to protect the temperature-sensitive items.

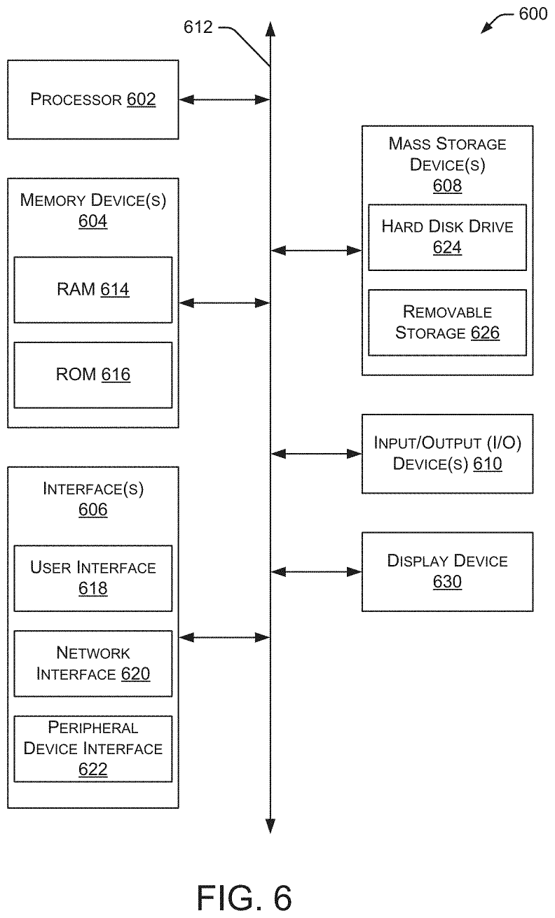

FIG. 6 illustrates an example block diagram of a computing device. Referring now to FIG. 6, a block diagram of an example computing device 600 is illustrated. Computing device 600 may be used to perform various procedures, such as those discussed herein. A computing device 600 may perform any of the functions or methods of the order processing system 102, delivery management system 104, communication manager 202, compartment control module 204, and/or any other computing entity. Computing device 600 can perform various delivery functions as discussed herein, and can execute one or more application programs, such as the application programs or functionality described herein. Computing device 600 can be any of a wide variety of computing devices, such as a desktop computer, in-dash computer, vehicle control system, a notebook computer, a server computer, a handheld computer, tablet computer and the like.

Computing device 600 includes one or more processor(s) 602, one or more memory device(s) 604, one or more interface(s) 606, one or more mass storage device(s) 608, one or more Input/Output (I/O) device(s) 610, and a display device 630 all of which are coupled to a bus 612. Processor(s) 602 include one or more processors or controllers that execute instructions stored in memory device(s) 604 and/or mass storage device(s) 608. Processor(s) 602 may also include various types of computer-readable media, such as cache memory.

Memory device(s) 604 include various computer-readable media, such as volatile memory (e.g., random access memory (RAM) 614) and/or nonvolatile memory (e.g., read-only memory (ROM) 616). Memory device(s) 604 may also include rewritable ROM, such as Flash memory.

Mass storage device(s) 608 include various computer readable media, such as magnetic tapes, magnetic disks, optical disks, solid-state memory (e.g., Flash memory), and so forth. As shown in FIG. 6, a particular mass storage device is a hard disk drive 624. Various drives may also be included in mass storage device(s) 608 to enable reading from and/or writing to the various computer readable media. Mass storage device(s) 608 include removable media 626 and/or non-removable media.

I/O device(s) 610 include various devices that allow data and/or other information to be input to or retrieved from computing device 600. Example I/O device(s) 610 include cursor control devices, keyboards, keypads, microphones, monitors or other display devices, speakers, printers, network interface cards, modems, and the like.

Display device 630 includes any type of device capable of displaying information to one or more users of computing device 600. Examples of display device 630 include a monitor, display terminal, video projection device, and the like.

Interface(s) 606 include various interfaces that allow computing device 600 to interact with other systems, devices, or computing environments. Example interface(s) 606 may include any number of different network interfaces 620, such as interfaces to local area networks (LANs), wide area networks (WANs), wireless networks, and the Internet. Other interface(s) include user interface 618 and peripheral device interface 622. The interface(s) 606 may also include one or more user interface elements 618. The interface(s) 606 may also include one or more peripheral interfaces such as interfaces for printers, pointing devices (mice, track pad, or any suitable user interface now known to those of ordinary skill in the field, or later discovered), keyboards, and the like.

Bus 612 allows processor(s) 602, memory device(s) 604, interface(s) 606, mass storage device(s) 608, and I/O device(s) 610 to communicate with one another, as well as other devices or components coupled to bus 612. Bus 612 represents one or more of several types of bus structures, such as a system bus, PCI bus, IEEE bus, USB bus, and so forth.

For purposes of illustration, programs and other executable program components are shown herein as discrete blocks, although it is understood that such programs and components may reside at various times in different storage components of computing device 600, and are executed by processor(s) 602. Alternatively, the systems and procedures described herein can be implemented in hardware, or a combination of hardware, software, and/or firmware. For example, one or more application specific integrated circuits (ASICs) can be programmed to carry out one or more of the systems and procedures described herein.

While various embodiments of the present disclosure are described herein, it should be understood that they are presented by way of example only, and not limitation. It will be apparent to persons skilled in the relevant art that various changes in form and detail can be made therein without departing from the spirit and scope of the disclosure. Thus, the breadth and scope of the present disclosure should not be limited by any of the described exemplary embodiments, but should be defined only in accordance with the following claims and their equivalents. The description herein is presented for the purposes of illustration and description. It is not intended to be exhaustive or to limit the disclosure to the precise form disclosed. Many modifications and variations are possible in light of the disclosed teaching. Further, it should be noted that any or all of the alternate implementations discussed herein may be used in any combination desired to form additional hybrid implementations of the disclosure.

1. A method comprising:
identifying a plurality of items for delivery to a vehicle;
determining, by a delivery management system, whether any of the plurality of items are temperature-sensitive;
responsive to identifying at least one temperature-sensitive item:
determining whether the vehicle has a variable-temperature compartment to receive the temperature-sensitive item; and
responsive to determining that the vehicle has a variable-temperature compartment, notifying the vehicle of an estimated delivery time for the temperature-sensitive items.

2. The method of claim 1, further comprising notifying the vehicle of the type of temperature-sensitive items being delivered responsive to determining that the vehicle has a variable-temperature compartment.

3. The method of claim 1, wherein determining whether the vehicle has a variable-temperature compartment includes determining whether the variable-temperature compartment can maintain a temperature required by the temperature-sensitive items.

4. The method of claim 1, wherein responsive to determining that the vehicle has a variable-temperature compartment, instructing the vehicle to adjust the temperature of the variable-temperature compartment to achieve a predetermined temperature prior to the estimated delivery time.

5. The method of claim 1, wherein the variable-temperature compartment can be adjusted to maintain temperatures to preserve at least one of frozen items, refrigerated items, and heated items.

6. The method of claim 1, further comprising initiating delivery of the plurality of items to the vehicle.

7. The method of claim 1, wherein determining whether the vehicle has a variable-temperature compartment to receive the temperature-sensitive item includes:
identifying a specific vehicle to receive the items;
determining whether the specific vehicle has variable-temperature compartments that can provide temperature environments required by the temperature-sensitive items.

8. The method of claim 1, wherein responsive to determining that the vehicle does not have a variable-temperature compartment, generating a message indicating that the vehicle cannot receive the temperature-sensitive items.

9. The method of claim 1, wherein the vehicle is an unattended vehicle at the estimated delivery time.

10. A method comprising:
receiving, by a control module in a vehicle, information related to delivery of a plurality of items to the vehicle, wherein the information includes an estimated delivery time and identifies temperature-sensitive items among the plurality of items;
determining, by the control module, a time to begin adjusting a temperature of a variable-temperature compartment in the vehicle based on the identified temperature-sensitive items and the estimated delivery time; and
providing access, by the control module, to the variable-temperature compartment upon delivery of the plurality of items to the vehicle.

11. The method of claim 10, further comprising generating, by the control module, a delivery acknowledgement message indicating that the plurality of items are stored in the vehicle.

12. The method of claim 10, wherein the received information further includes temperature environments required by the temperature-sensitive items.

13. The method of claim 10, further comprising maintaining, by the control module, a proper temperature in the variable-temperature compartment.

14. The method of claim 10, further comprising monitoring, by the control module, power provided from a vehicle battery to the variable-temperature compartment.

15. The method of claim 14, further comprising starting a vehicle engine, by the control module, responsive to detecting power from the vehicle battery falling below a threshold.

16. The method of claim 10, wherein the variable-temperature compartment can be adjusted by the control module to maintain temperatures to preserve at least one of frozen items, refrigerated items, and heated items.

17. The method of claim 10, wherein the vehicle is an unattended vehicle at the estimated delivery time.

18. An apparatus comprising:
a processor; and
a memory device coupled to the processor, the memory device configured to store instructions for execution on the processor, the instructions causing the processor to:
identify a plurality of items for delivery to a vehicle;
determine whether any of the plurality of items are temperature-sensitive;
responsive to identifying at least one temperature-sensitive item:
determine whether the vehicle has a variable-temperature compartment to receive the temperature-sensitive item; and
responsive to determining that the vehicle has a variable-temperature compartment, notify the vehicle of an estimated delivery time for the temperature-sensitive items.

19. The apparatus of claim 18, wherein the variable-temperature compartment in the vehicle can be adjusted to maintain temperatures to preserve at least one of frozen items, refrigerated items, and heated items.

20. The apparatus of claim 18, wherein the instructions further cause the processor to notify the vehicle of the type of temperature-sensitive items being delivered responsive to determining that the vehicle has a variable-temperature compartment to receive the temperature-sensitive items.
